(19) United States
(12) Patent Application Publication
(10) Pub. No.: US 2026/0308768 A1
(43) Pub. Date: Oct. 8, 2026

(54) Method for the Corrosion-Protective Pretreatment of Components Comprising Surfaces of Zinc-Magnesium Hot-Dip Coated Steel

(71) Applicant: Henkel AG & Co. KGaA, Duesseldorf (DE)

(72) Inventors: Jan-Willem Brouwer, Willich (DE); Frank-Oliver Pilarek, Bergheim (DE); Kristof Wapner, Duesseldorf (DE); Fernando Jose Resano Artalejo, Duesseldorf (DE); Christina Angenendt, Straelen (DE); Andreas Arnold, Hilden (DE); Nadine Isabel Millies, Leichlingen (DE)

(21) Appl. No.: 19/683,257

(22) Filed: May 20, 2026

Related U.S. Application Data
(63) Continuation of application No. PCT/EP2024/083447, filed on Nov. 25, 2024.

(30) Foreign Application Priority Data
Nov. 29, 2023 (EP) 23212932

(51) Int. Cl. C23C 28/00; C09D 5/44; C23C 22/36; C23C 22/78; C23C 22/82

(52) U.S. Cl. CPC C23C 28/3225; C09D 5/4457; C23C 22/361; C23C 22/78; C23C 22/82

(57) ABSTRACT

A method for the corrosion-protective pretreatment of a plurality of components comprising surfaces of zinc-magnesium hot-dip coated steel, in which the components each successively pass through a degreasing stage, a conversion stage and a painting stage wherein the conversion stage based on an acidic aqueous conversion solution of compounds of the elements Zr and/or Ti dissolved in water is adjusted in pH value and free fluoride content such that homogeneous conversion layers are produced on the zinc-magnesium hot-dip coated steel that reliably provide high paint adhesion regardless of the degree of soiling of the degreasing stage.

The present invention relates to a method for the corrosion-protective pretreatment of a plurality of components comprising surfaces of zinc-magnesium hot-dip coated steel, in which the components each successively pass through a degreasing stage, a conversion stage and a painting stage. The conversion stage based on an acidic aqueous conversion solution of compounds of the elements Zr and/or Ti dissolved in water is adjusted in terms of pH value and free fluoride content so that homogeneous conversion layers are produced on the zinc-magnesium hot-dip coated steel, which reliably provide high paint adhesion regardless of the degree of soiling of the degreasing stage.

In automotive manufacturing, the use of zinc coatings alloyed with magnesium on steel is gaining importance due to the increasing demand for bodies in lightweight construction. In comparison with other hot-dip galvanizations, a coating of zinc and magnesium can provide a significantly increased anti-corrosion effect and, in particular, excellent resistance to corrosive delamination even after painting with organic topcoats and dipping paints. Due to this improved property profile, coatings in a smaller layer thickness can be provided, which nevertheless meet the high demands on recoatability and corrosion protection. The good properties of zinc coatings alloyed with magnesium in corrosion behavior, especially in edge corrosion protection and paint adhesion to formed components, combined with outstanding compatibility with all common joining methods and the aforementioned weight savings, make hot-dip galvanized (ZM) steel sheet a material of particular importance for the production of lightweight car bodies, and therefore the surface area proportion of this material in the car body will continue to increase alongside the surface area proportion of other light metals such as aluminum in automotive manufacturing.

Zinc coatings alloyed with magnesium on steel are commonly used in automotive manufacturing as flat strip products and so-called hot-dip galvanized (ZM) steel strip. Such zinc-magnesium hot-dip coated steel contains, in the metallic coating, approximately 1.5 to 8 wt. % of the metals aluminum and magnesium, the proportion of magnesium being at least 0.2 wt. %. The basic suitability of these coatings in conventional methods established in the prior art for being shaped, pretreated and coated are recognized and demonstrated in principle (Characteristic Properties 095 E, “Continuously Hot-Dip Coated Steel Strip and Sheet,” Chapters 8 and 10, 2017 edition, Wirtschaftsvereinigung Stahl), but on the basis of the particular composition of the coating and the native oxide layer, there are special features which have to be taken into account, in particular in the case of cleaning and pretreatment, for a coating result which is as homogeneous and reproducible as possible and thus optimal anti-corrosion characteristics or the desired surface functionality.

It is known from the prior art, for example, that in the course of cleaning, prior to a corrosion-protective pretreatment of hot-dip galvanized (ZM) strip steel, a change in the proportion of oxides of the alloy constituent magnesium may be necessary for sufficient adhesion to a subsequently applied paint layer. For example, US 2016/0010216 A1 reports that the extensive removal of magnesium oxide in the oxide layer close to the surface of hot-dip galvanized (ZM) strip steel can effectively suppress the occurrence of blister-like protrusions in the topcoat.

It is also documented in the prior art that, in the serial pretreatment of a plurality of components, even the wetting and thus the reliable cleaning of the material surfaces of hot-dip galvanized (ZM) strip steel can be problematic. WO 2023/036889 A1 therefore proposes conditioning the hot-dip galvanized (ZM) surfaces after degreasing but before a corrosion-protective pretreatment, which can be a conversion coating based on the elements Zr and/or Ti, in order to counteract the aging of conventional cleaning and degreasing baths associated with high component throughput and the subsequent deterioration in the wettability of the hot-dip galvanized (ZM) surfaces.

Materials with zinc-magnesium coatings therefore require sophisticated process control in order to undergo successfully and, above all, reliably corrosion-protective pretreatment, especially when it is necessary to provide high-quality coating of a plurality of components in an automated manner in a paint line. Further approaches are needed here that support a simpler process control during the corrosion-protective pretreatment, comprising the stages of degreasing, formation of the conversion layer and painting, and that contribute to achieving satisfactory results in the serial treatment of a plurality of components, largely independent of bath aging, thus fully exploiting the potential of zinc-magnesium hot-dip coated materials in corrosion protection. The approaches known in the prior art of intensive bath maintenance to keep the cleaning and degreasing baths as free from contamination as possible and to replace them with fresh bath solutions as early as possible is economically disadvantageous and problematic with regard to the desirable resource-saving use of process chemicals.

The object of the present invention is therefore to establish a method for the serial treatment of a plurality of components that is suitable for reliably corrosion-protectively pretreating zinc-magnesium hot-dip coated steel using a conventional method sequence, taking into account a conversion coating based on the elements Zr and/or Ti, which on the one hand can provide an excellent base for paint adhesion for the metallic material mix commonly used in automotive manufacturing, but on the other hand has also proven to be particularly susceptible to a decline in performance during the stationary operation of a pretreatment line in the treatment of zinc-magnesium hot-dip coated steel.

Surprisingly, it has now been found that a specific loading of the degreasing bath with nonpolar hydrocarbons, which are introduced into the bath from components contaminated with anti-corrosion oils, forming oils and drawing greases, above a critical value, means that an initially stable subsequent conversion treatment based on the elements Zr and/or Ti no longer delivers the desired result and, after the paint layer build-up, a significant loss of paint adhesion is observed specifically on the steel substrates with zinc-magnesium coating. The present invention does not address the problem by modifying method steps upstream of the conversion treatment, but surprisingly via the property profile of the conversion treatment itself and by adjusting the content of free fluoride.

Specifically, the present invention relates to a method for the corrosion-protective pretreatment of a plurality of components in series, in which the components of the series at least partially have surfaces of zinc-magnesium hot-dip coated steel, and in which the components of the series each undergo the successive method steps i)-iii), and at least the surfaces of the zinc-magnesium hot-dip coated steel are successively brought into contact with the respectively provided aqueous solutions (I)-(III):
i) degreasing stage providing an alkaline aqueous composition (I) having a pH above 9.00;
ii) conversion stage providing an acidic aqueous composition (II) having a pH in the range of 3.50 to 5.20, containing at least 0.05 mmol/kg of compounds of the elements Zr and/or Ti dissolved in water and at least 2.80 mmol/kg of free fluoride; and
iii) painting stage providing an aqueous dispersion (III) of an organic binder.

Corrosion-protective pretreatment of components in series is when a plurality of components are brought into contact with treatment solution provided in the respective treatment stages of the method according to the invention and conventionally stored in system tanks, the individual components being brought into contact successively and thus at different times from one another. In this case, the system tank is the container in which the treatment solution is located for the purpose of anti-corrosion pre-treatment in series.

According to the invention, the components comprise the material steel, which is provided with a metallic zinc-magnesium coating, wherein the coating is applied from a melt of the alloy constituents. Such hot-dip galvanizations are referred to in the prior art as hot-dip galvanized (ZM) steel and are metallic coatings containing 1.5 to 8 wt. % of the metals aluminum and magnesium, the proportion of magnesium in the metallic coating preferably being at least 0.2 wt. %. In the following, the term hot-dip galvanized (ZM) steel is used synonymously with zinc-magnesium hot-dip coated steel.

A corrosion-protective pretreatment within the meaning of the present invention always relates to the pretreatment of the surfaces, formed by the metallic materials, of the components of the series. The material can be a uniform material or a coating. According to the invention, galvanized steel grades consist both of the material steel and of the material zinc, it being possible for surfaces of steel to be exposed at the cutting edges and cylindrical grinding points of, for example, an automobile body which is made of galvanized steel, in which case according to the invention there is pre-treatment of the material steel. Therefore, if the present invention refers to the pretreatment of a component composed of a specific metallic material, this comprises all materials and coatings that contain more than 50 at. % of the relevant element of said material. Accordingly, a component with a galvanization contains more than 50 at. % zinc in its metallic coating.

The method according to the invention is not limited to application to hot-dip galvanized (ZM) steel, and therefore the usual substrates provided by the steel industry, such as steel, in particular cold-rolled steel (CRS), and electrolytically galvanized (ZE) or hot-galvanized (Z), alloy-galvanized, in particular (ZF), (ZA), or aluminum-coated (AZ), (AS) steel, are also suitable as further constituents of the components. In the method according to the invention, light metals such as aluminum and magnesium and their alloys can also be treated together with the hot-dip galvanized (ZM) steel of the component and be cleaned and/or undergo corrosion-protective pretreatment in the process. The method according to the invention is characterized precisely by the fact that it is suitable for the corrosion-protective pretreatment of common metal materials composed of iron, zinc, aluminum and magnesium, i.e., providing them with a conversion coating that provides a good primed base for paint.

A particularly preferred embodiment is one in which the components of the series are composed of galvanized steel, steel and/or aluminum in addition to the hot-dip galvanized (ZM) steel. The suitability of the method according to the invention for providing a good corrosion-protective pretreatment consisting of cleaning, formation of the conversion layer and painting for this material mix is advantageous in particular for components that are manufactured in composite structure and assembled from different semi-finished products. A preferred method according to the invention is therefore one in which the components of the series are composite structures, preferably automobile bodies, which are composed of semi-finished products of hot-dip galvanized (ZM) steel and of semi-finished products of galvanized steel and aluminum, and are particularly preferably assembled from semi-finished products of hot-dip galvanized (ZM) steel and from semi-finished products of galvanized steel, aluminum and steel.

The components pretreated according to the present invention can be any three-dimensional structures of any shape and design that originate from a manufacturing process, in particular also semi-finished products such as strips, sheets, rods, pipes, etc. and composite structures assembled from the aforementioned semi-finished products. The composite structures assembled from different materials are generally in the form of flat products which are cut to size, shaped, and joined by welding, adhesive bonding and flanging. The components which are to be pretreated in series according to the present invention are preferably selected from automobile bodies or parts thereof, heat exchangers, profiles, pipes, tanks or troughs.

Insofar as the concentration of an active component or compound is referred to in the context of the present invention as the amount of substance per kilogram, this is the amount of substance based on the weight of the respective total composition.

With regard to the method steps, a composition (I)-(II) or dispersion (III) is considered to be “provided” within the meaning of the method according to the invention when, as specified in the relevant treatment stage (i)-(iii), it is either stored in system tanks and held ready for application for contacting or is implemented during contacting as defined.

The multi-stage pretreatment in accordance with the present invention ensures that in the conversion stage, for a plurality of components to be treated, conversion coatings based on Zr and/or Ti are produced that provide good paint adhesion and thus reliably protect against corrosive delamination of the entire paint layer system. This is achieved by adjusting the free fluoride content within the specified pH range, regardless of the loading of the degreasing stage with contaminants removed from the component surfaces. In particular, the proportion of nonpolar hydrocarbons has proven to be critical in the meaning that, above a certain stationary proportion of hydrocarbons introduced into the degreasing bath, a significant deterioration in the paint adhesion to the hot-dip galvanized (ZM) surfaces of the correspondingly pretreated components results if the specified proportion of free fluoride is not met in the conversion stage. It has also been found that the amount of free fluoride required to overcome the loss of paint adhesion to the hot-dip galvanized (ZM) surfaces occurring during the serial treatment of components contaminated with fats and oils depends less on the actual loading of the degreasing bath with nonpolar constituents than on the pH of the conversion stage. At lower pH values, a larger amount of free fluoride tends to be required to compensate for the adverse effect on the hot-dip galvanized (ZM) surfaces, which would otherwise inevitably occur during serial treatment due to the successive build-up of a stationary proportion of hydrocarbons in the degreasing stage.

### Degreasing Stage:

In the degreasing stage, an alkaline aqueous composition (I) having a pH above 9.00 is provided for cleaning and degreasing the components of the series. The aim of the degreasing stage is to ensure that, for a subsequent successful corrosion-protective pretreatment consisting of the conversion and painting stages, the component surface is largely free of inorganic salts and organic contaminants, in particular drawing, forming, rolling and anti-corrosion oils. In a preferred embodiment, immediately after passing through the degreasing stage, i.e., before the conversion stage but after a rinsing step with deionized water (κ<1 μScm⁻¹), a carbon deposit of less than 0.20 g/m², particularly preferably less than 0.10 g/m², remains on the surface, formed by the metallic materials, of the components of the series, whereas the surface, formed by the metallic materials, of the components of the series previously, i.e., before undergoing method step i), as immediately before being brought into contact with the alkaline aqueous composition (I), preferably has a carbon deposit of at least 0.50 g/m², which originates from the aforementioned organic contaminants. The layer deposit of carbon remaining on the surfaces formed by the metal materials of the components can be determined by pyrolytic decomposition. For this purpose, a representative component portion of defined area is brought to 550° C. substrate temperature (PMT) in an oxygen atmosphere, and the amount of carbon dioxide released is determined quantitatively by means of infrared sensor as an amount of carbon, for example by means of the analysis device LECO® RC-412 Multiphase Carbon Determinator (Leco Corp.).

In continuous operation, i.e., during the treatment of a plurality of components of a series, the contaminants absorbed by the alkaline aqueous cleaner therefore accumulate in the degreasing bath. It has now been established that in the method according to the invention, the paint adhesion to the hot-dip galvanized (ZM) surfaces can be maintained even when the proportion of nonpolar hydrocarbons in the degreasing bath exceeds a critical threshold value. The method according to the invention is therefore advantageous when the critical threshold value is reached and exceeded in the degreasing bath. Even above a proportion of 0.05 kg/m³ nonpolar hydrocarbons in the degreasing bath, a significant deterioration in the paint adhesion to the hot-dip galvanized (ZM) steel can occur if a corrosion-protective pretreatment as described in the conversion stage ii) is not carried out as specified according to the invention. In this respect, the method according to the invention takes full effect as soon as nonpolar hydrocarbons have accumulated in the degreasing bath due to the serial treatment of a plurality of components, preferably at least 0.05 kg/m³, particularly preferably at least 0.10 kg/m³, in particular at least 0.20 kg/m³ nonpolar hydrocarbons. The proportion of nonpolar hydrocarbons in the degreasing bath can be determined in a sample of the degreasing bath that has been adjusted with hydrochloric acid (methyl orange transition point) and to which an aliquot part ( 1/10) of sodium chloride and an aliquot part (¼) of ethanol have been added. From this prepared sample of the degreasing bath, the proportion of hydrocarbons is extracted by shaking with an aliquot part (1/1) of petroleum ether. After phase separation, aided by the successive addition of ethanol, the petroleum ether phase is mixed with silica gel to separate polar organic constituents such as fatty acids, acid esters and non-ionic surfactants. After filtration, the proportion of nonpolar hydrocarbons can be determined gravimetrically after the petroleum ether has been distilled off.

The critical threshold value for nonpolar hydrocarbons is only reached after a certain number of components have passed through. In this context, it is preferred that the series of components comprises a number of components whose total surface area formed by the metallic materials of the components is greater than the following term:

$$\frac{{V}_{B} \cdot {KW}_{crit}}{Δ {m}_{TOC} \cdot 1.2}$$

VB: volume of the system tank of the degreasing stage in m³
KW_{crit}: critical threshold value for the proportion of nonpolar hydrocarbons in the system tank of the degreasing stage in kg/m³, wherein the critical threshold is 0.05 kg/m³, preferably 0.1 kg/m³, particularly preferably 0.2 kg/m³
Δm_{TOC}: change in the carbon content per unit area on the surfaces, formed by the metallic materials, of the components after the degreasing stage in kg/m²

The aforementioned properties of the degreasing stage, in particular with regard to the proportion of nonpolar hydrocarbons present, always refer to the last degreasing stage that precedes the conversion stage. In industry, it is quite common to use multiple degreasing stages to sufficiently remove stains from the components to be pretreated and to optimally condition the metal substrates for the subsequent conversion stage by acid cleaning. Therefore, for the determination of the critical threshold value of nonpolar hydrocarbons according to the aforementioned term, the amount of hydrocarbons in the volume of the system tank of the last degreasing stage must be taken into account, and analogously, for the change in the carbon content per unit area on the surfaces, formed by the metallic materials, of the components, the change after the last degreasing stage must be taken into account.

The pH of the alkaline aqueous composition (I) is preferably at least 9.50, particularly preferably at least 10.5, for good degreasing performance. However, only a slight to moderate acid cleaning of the zinc-magnesium coating can be advantageous for maintaining the good corrosion-protective properties of the (ZM) substrate, and therefore the pH is preferably less than 12.50, particularly preferably less than 12.00 and very particularly preferably less than 11.50.

According to the invention, the pH in the context of the degreasing stage corresponds to the negative decadic logarithm of the hydronium ion activity measured in the alkaline aqueous composition (I) at a temperature of 20° C. by means of a pH-sensitive glass electrode after two-point calibration against technical buffer solutions of acetic acid/acetate (pH=4.0) and boric acid/borate (pH=9.0).

Preferably, the alkaline aqueous cleaner is provided with a specific buffer capacity so that in the method according to the invention it has a total alkalinity at points of at least 5.0, particularly preferably of at least 8.0, very particularly preferably of at least 10.0, but preferably a total alkalinity of 30.0, particularly preferably of 20.0, is not exceeded. The total alkalinity corresponds to the consumption of 0.1 N hydrochloric acid in milliliters after titration of a sample volume of 10 ml of the alkaline aqueous composition (I), diluted with 50 ml deionized water (κ<1 μScm⁻¹), in the presence of the indicator bromcresol green (transition point: pH 3.6) at a temperature of 20° C.

To adjust the alkalinity of the alkaline aqueous composition (I), all builders known in the prior art that are alkaline-reacting compounds or a mixture of such compounds can be used. Particularly suitable and established builders are alkaline-reacting, inorganic compounds that are preferred in the context of the present invention and are particularly preferably selected from water-soluble hydroxides, carbonates, borates, silicates and/or phosphates, wherein in turn preferably at least water-soluble phosphates are present, which in turn are preferably selected from orthophosphates, pyrophosphates and/or tripolyphosphates. Suitable builders are therefore alkali metal carbonates, preferably selected from potassium carbonate, mixtures of alkali metal hydroxides, preferably selected from potassium hydroxide, with phosphoric acid and/or with boric acid and alkali metal tripolyphosphates, preferably selected from potassium tripolyphosphate.

The alkaline aqueous composition (I) contains at least one surface-active substance, preferably selected from surfactants, for effective degreasing. Surfactants within the meaning of the present invention are considered to be surface-active organic compounds which, for their surface activity, are composed of a hydrophilic and at least one lipophilic molecular component or of a lipophilic and at least one hydrophilic molecular component, the molecular weight of the surface-active organic compound not exceeding 2000 g/mol.

The surfactants used in the degreasing stage in method step i) of the method according to the invention can be selected from anionic surfactants, cationic surfactants, zwitterionic surfactants and non-ionic surfactants, the use of non-ionic surfactants generally being preferred. Particularly suitable non-ionic surfactants as constituents of the alkaline aqueous composition (I) for degreasing components comprising hot-dip galvanized (ZM) surfaces are those with an HLB value (hydrophilic-lipophilic balance) of at least 8, particularly preferably at least 10, in particular preferably at least 12, but particularly preferably no more than 18, in particular preferably no more than 16. The HLB value serves as a quantitative reference variable for the classification of non-ionic surfactants with regard to their miscibility with water or their property of forming O/W emulsions. For quantification, a breakdown of the non-ionic surfactant into a lipophilic and a hydrophilic group is carried out. The HLB value is then calculated as follows and can assume values of zero to 20 on the arbitrary scale:

$$HLB = 20 \cdot ( 1 - {M}_{L} / M )$$

where M_{L}: molar mass of the lipophilic group of the non-ionic surfactant
M: molar mass of the non-ionic surfactant

Non-ionic surfactants preferred in the degreasing stage of the method according to the invention are those that are selected from alkoxylated alkyl alcohols, alkoxylated fatty amines and/or alkyl polyglycosides, particularly preferably from alkoxylated alkyl alcohols and/or alkoxylated fatty amines, in particular preferably from alkoxylated alkyl alcohols. In this case, for a defoaming effect, the alkoxylated alkyl alcohols and/or alkoxylated fatty amines are preferably end-capped, particularly preferably having an alkyl group which in turn preferably has no more than 8 carbon atoms, particularly preferably no more than 4 carbon atoms. Alkoxylated alkyl alcohols and/or alkoxylated fatty amines particularly preferably used as non-ionic surfactants in the degreasing stage of the method according to the invention are those that are present in ethoxylated and/or propoxylated form, the number of alkylene oxide units preferably being no greater than 16, particularly preferably no greater than 12, in particular preferably no greater than 10, but particularly preferably greater than 4, in particular preferably greater than 6.

With regard to the lipophilic constituent of the aforementioned non-ionic surfactants, preferred alkoxylated alkyl alcohols and/or alkoxylated fatty amines as non-ionic surfactants in the degreasing stage of the method according to the invention are those in which the alkyl group is saturated and preferably unbranched, the number of carbon atoms in the alkyl group preferably being greater than 6, particularly preferably at least 10, in particular preferably at least 12, but preferably no greater than 20, particularly preferably no greater than 18, in particular preferably no greater than 16.

Overall, it is apparent that longer-chain non-ionic surfactants are very suitable and preferred for effective cleaning and degreasing of conventional drawing, forming, rolling and anti-corrosion oils, so that in a further preferred embodiment of the method according to the invention, the alkoxylated alkyl alcohols and/or alkoxylated fatty amines, in particular the alkoxylated alkyl alcohols, that are preferred as the surfactant constituent of the alkaline aqueous composition (I) are those whose lipophilic alkyl group comprises at least 10 carbon atoms, particularly preferably at least 12 carbon atoms, the longest carbon chain in the alkyl group consisting of at least 8 carbon atoms and an HLB value in the range from 12 to 16 being present.

Preferred representatives of the alkoxylated alkyl alcohols are selected, for example, from
four- to eight-fold ethoxylated or propoxylated C6-C12 fatty alcohols,
eight to twelve-fold ethoxylated C12-C18 fatty alcohols,
six to fourteen-fold propoxylated C12-C18 fatty alcohols,
six to ten-fold ethoxylated and propoxylated C12-C14 fatty alcohols, which can in turn be present in methyl, butyl- or benzyl-end group-closed form.

The cloud point determined according to DIN 53 917 (1981) is a further suitable selection criterion for the non-ionic surfactant to be used in the degreasing stage, which is selected from alkoxylated alkyl alcohols, alkoxylated fatty amines and/or alkyl polyglycosides, and is preferably above 20° C., but particularly preferably below the application temperature of the alkaline aqueous composition (I) in the degreasing stage, in particular preferably more than 5° C., but no more than 10° C., below the respectively selected application temperature of the alkaline aqueous composition (I) for degreasing.

The proportion of the surfactants, in particular the non-ionic surfactants, in the alkaline aqueous composition (I) of the degreasing stage is preferably above 0.01 wt. %, particularly preferably above 0.10 wt. %, in particular preferably above 0.20 wt. %, but preferably not above 2.00 wt. %, in each case based on the alkaline aqueous composition (I).

Furthermore, the alkaline aqueous composition (I) preferably contains alkaline builders selected from phosphates, pyrophosphates, phosphoric acid, silicates, carbonates and hydroxides, as well as mixtures of these builder substances, to provide its alkalinity.

For a resource-saving method and for reasons of economy, it is preferred if the alkaline aqueous composition (I) of the conversion stage in a method according to the invention contains
(a) in each case less than 10 mg/kg of compounds of the metals Bi, Ni, Co and/or Cu dissolved in water, calculated as the amount of the respective element in the aqueous composition, preferably in each case less than 10 mg/kg of compounds of such metals dissolved in water which have a standard reduction potential of greater than −0.40 V (SHE), calculated as the amount of the respective element in the aqueous composition,
(b) a total of less than 0.01 g/L (calculated as solid additive) of copolymers that have, in alternating configuration, monomer units having at least one carboxylic acid group, phosphonic acid group and/or sulfonic acid group and monomer units having no acid group, preferably a total of less than 0.1 g/L (calculated as solid additive) of copolymers that have monomer units having at least one carboxylic acid group, phosphonic acid group and/or sulfonic acid group, particularly preferably less than 0.1 g/L of organic polymers that do are not any of the aforementioned surface-active substances with a molecular weight of no more than 2000 g/mol.

The application and thus the bringing into contact of the alkaline aqueous composition (I) preferably takes place at at least 30° C., particularly preferably at least 40° C., but preferably below 60° C. The alkaline aqueous composition (I) of the degreasing stage can be brought into contact with the components of the series by means of application types established in the prior art. These include in particular dipping, rinsing, spraying and/or misting, wherein the immersion of the components of the series takes place into a system basin of the degreasing stage containing the corresponding alkaline aqueous composition (I) and/or by spraying on the alkaline aqueous composition (I) stored in a system basin. As previously discussed, the conversion stage can be preceded by multiple degreasing stages, which are in turn fed with an alkaline composition via their own storing system basins.

### Conversion Stage:

According to the invention, the conversion treatment in method step ii) must be carried out with acidic aqueous compositions containing at least 2.80 mmol/kg of free fluoride, otherwise it is often not ensured that the resulting paint adhesion to the hot-dip galvanized (ZM) surfaces behaves largely indifferently to the nonpolar hydrocarbons enriched in the degreasing stage.

However, it has been found that higher proportions of free fluoride for paint adhesion to the hot-dip galvanized (ZM) surfaces of the components treated in the method according to the invention do not have a detrimental effect on corrosion protection, while at the same time even moderate increases in the free fluoride content further increase the reliability of the method according to the invention in that even significant increases in the proportion of nonpolar hydrocarbons enriched in the degreasing bath are tolerated without loss of performance. In preferred embodiments, the acidic aqueous composition (II) of the conversion stage in method step ii) therefore contains at least 3.00 mmol/kg, particularly preferably at least 3.20 mmol/kg, very particularly preferably at least 3.40 mmol/kg of free fluoride. However, for reasons of the compatibility of the method according to the invention with other metallic materials, in particular steel, it is preferred if the proportion of free fluoride in the acidic aqueous composition (II) is less than 7.50 mmol/kg, particularly preferably less than 6.00 mmol/kg and very particularly preferably less than 5.00 mmol/kg. Since technical components made of galvanized (ZM) steel that are corrosion-protectively treated in series in accordance with the method according to the invention generally also have steel surfaces, such as on the cut edges or ground-through areas of the semi-finished products made of galvanized (ZM) steel, which are available, for example, as cut sheets formed into body parts, limiting the free fluoride content in the conversion stage to the aforementioned upper limits is generally advantageous for fully satisfactory corrosion protection, even of components made solely of hot-dip galvanized (ZM) steel, in order to avoid flash rust on the aforementioned exposed steel surfaces.

The amount of free fluoride in the respective stages of the pretreatment according to the invention can be determined potentiometrically by means of a fluoride-sensitive measuring electrode at 20° C. in the relevant provided solution after calibration with fluoride-containing buffer solutions without pH buffering.

The pH of the acidic aqueous composition (II) in the conversion stage is also significant and generally advantageous for reliably good paint adhesion to the hot-dip galvanized (ZM) surfaces, if somewhat higher free fluoride contents are present at lower pH values, and preferably a minimum amount of free fluoride in mmol/kg is present, which is calculated for the method according to the invention according to the following terms listed in increasing order of preference:

$$\begin{matrix}4.4 - \frac{2.4}{1.7} \cdot ( pH - 3.5 ) , \\ 4.4 - \frac{2.}{1.7} \cdot ( pH - 3.5 ) , \\ 4.4 - \frac{1.8}{1.7} \cdot ( pH - 3.5 ) , \\ 4.4 - \frac{1.6}{1.7} \cdot ( pH - 3.5 ) , \\ 4.4 - \frac{1.4}{1.7} \cdot ( pH - 3.5 ) ,\end{matrix}$$

wherein, in each case, the pH of the acidic aqueous composition (II) is to be used for the “pH.”

Alternatively, depending on the pH of the acidic aqueous composition (II), a preferred minimum amount of free fluoride can be used, which is calculated according to the following term:

$$2 + 1.85 \cdot \sqrt{5.2 - pH} ,$$

wherein, in turn in each case, the pH of the acidic aqueous composition (II) is to be used for the “pH,” which in this context is preferably less than 5.00.

In a particularly preferred embodiment, the minimum amount of free fluoride that should be present in the acidic aqueous composition for optimal paint adhesion to the (ZM) surfaces is to be adjusted as follows, depending on the pH and the proportion of nonpolar hydrocarbons:

$$1.2 + 5 \cdot \sqrt{0.1 \cdot KW} + 1.85 \cdot \sqrt{5.2 - pH}$$

where
pH: pH of the acidic aqueous composition (II), which is less than 4.80, and preferably greater than 4.00, otherwise corrosion may occur on exposed steel surfaces of the hot-dip galvanized (ZM) steel processed into components due to the high minimum fluoride content.
KW: dimensionless proportion of nonpolar hydrocarbons in the alkaline aqueous composition (I) in the system tank of the degreasing stage in kg/m³, which is at least 0.10 kg/m³, but preferably does not exceed 0.80 kg/m³, particularly preferably 0.60 kg/m³, otherwise corrosion may occur on exposed steel surfaces of the hot-dip galvanized (ZM) steel processed into components due to the high minimum fluoride content.

Suitable sources of free fluoride for the acidic aqueous composition (II) are water-soluble complex fluorides of the elements Zr, Ti and/or Si, preferably of the elements Zr and/or Ti, particularly preferably of the element Zr, and/or hydrofluoric acid, ammonium bifluoride and/or water-soluble alkali metal fluorides.

Regarding the pH of the acidic aqueous composition of the conversion stage, it should first be noted that the compounds of the elements Zr and/or Ti dissolved in water do not form a saline solution due to hydrolysis, which is then no longer available for the formation of the conversion layer. At the same time, the acid cleaning rate for the common metal materials should be sufficiently high to form homogeneous sealed conversion layers; this applies in particular to the substrate hot-dip galvanized (ZM) steel. It is therefore necessary according to the invention that the acidic aqueous compositions (II) do not have a pH above 5.20, and that the pH is preferably less than 5.10, particularly preferably less than 5.00, very particularly preferably less than 4.90 and in particular preferably below 4.80. At the same time, increased acid cleaning and rapid layer formation kinetics can be detrimental to the formation of suitable conversion coatings. In the lower pH range according to the invention, in particular on hot-dip galvanized (ZM) steel, comparatively high layer weights with respect to the elements Zr and/or Ti are achieved, which in turn are less compact and themselves tend to corrode at low pH values, so that point defects can form in the conversion coating. According to the invention, it is therefore preferred if the pH of the acidic aqueous composition (II) is greater than 4.00, particularly preferably greater than 4.20, and very particularly preferably greater than 4.40.

According to the invention, in the context of the conversion stage, the pH corresponds to the negative decadic logarithm of the hydronium ion activity measured in the acidic aqueous composition (II) at a temperature of 20° C. by means of a pH-sensitive glass electrode after two-point calibration against technical buffer solutions of acetic acid/acetate (pH=4.0) and phosphate (pH=7.0).

In the conversion stage, the aim is therefore to build up a conversion coating that is as homogeneous and compact as possible, based on oxide/hydroxide compounds of the elements Zr and/or Ti, preferably of the element Zr. In a preferred embodiment, the bringing into contact is therefore carried out at least for a duration for which a layer deposit of at least 20 mg/m², particularly preferably of at least 40 mg/m², is brought about on the surfaces of the hot-dip galvanized (ZM) steel, but the bringing into contact preferably does not continue for so long that a layer deposit of more than 250 mg/m², particularly preferably more than 150 mg/m², very particularly preferably more than 100 mg/m², in particular preferably more than 80 mg/m² results, in each case based on the elements Zr and/or Ti on the hot-dip galvanized (ZM) surfaces. The layer deposits can be determined by means of X-ray fluorescence analysis (XRF). The treatment time required for the preferred layer deposits, i.e., the duration of bringing into contact with the acidic aqueous composition (II) at a preferred temperature in the range of 10-60° C., should be in the range of 10 seconds to 300 seconds. In order to ensure this, a method according to the invention is preferred in which, in the acidic aqueous composition (II) in method step ii), the proportion of compounds of the elements Zr and/or Ti dissolved in water is preferably at least 0.10 mmol/kg, particularly preferably at least 0.30 mmol/kg, in particular preferably at least 0.40 mmol/kg. For reasons of process economy, the contents of compounds of the elements Zr and/or Ti dissolved in water should preferably be below 5.0 mmol/kg, particularly preferably below 3.0 mmol/kg and very particularly preferably below 2.0 mmol/kg, based on the elements Zr and/or Ti.

In the conversion stage of the method according to the invention, an amorphous oxide/hydroxide coating based on the elements Zr and/or Ti, preferably the element Zr, is to be achieved, and accordingly the compounds of the elements Zr and/or Ti dissolved in water are present. The term “dissolved in water” comprises molecularly dissolved species and compounds that dissociate in aqueous solution and form hydrated ions. Typical representatives of these compounds are titanyl sulfate (TiO(SO₄)), titanyl nitrate (TiO(NO₃)₂) and/or hexafluorotitanic acid (H₂TiF₆) and salts thereof or ammonium zirconium carbonate ((NH₄)₂ZrO(CO₃)₂) and/or hexafluorozirconic acid (H₂ZrF₆) and salts thereof. The compounds dissolved in water in the conversion stage are preferably selected from fluoro acids and/or fluoro complexes of the elements Zr and/or Ti and the water-soluble salts thereof. The conversion layer formation based on the fluoro acids and/or fluoro complexes of the element Zr is particularly preferred, because conversion layers of this kind provide improved paint adhesion.

To repair point defects in the conversion coating growing on the surfaces of galvanized steel, in particular on the surfaces of hot-dip galvanized (ZM) steel, in method step ii), in which an overall rapid layer formation takes place, the presence of copper ions can be advantageous, the local cementation of which in the point defects provides improved corrosion protection. Accordingly, it is preferred that the acidic aqueous composition (II) of the conversion stage in method step ii) additionally contains copper ions dissolved in water, preferably at least 0.05 mmol/kg, but in turn preferably less than 4.0 mmol/kg, particularly preferably less than 2.0 mmol/kg of copper ions dissolved in water. Suitable sources of copper ions dissolved in water are water-soluble salts such as copper nitrate (Cu(NO₃)₂), copper sulfate (CuSO₄) and copper acetate (Cu(CH₃COO)₂).

Other additives known to the person skilled in the art of surface treatment, such as accelerators like nitrate ions, nitrite ions, nitroguanidine, N-methylmorpholine N-oxide, hydrogen peroxide in free or bound form, hydroxylamine in free or bound form, reducing sugars, and/or wetting agents like non-ionic surfactants, and/or polymers like polyamidoamines, and/or cations/compounds of the elements Mg, Ca, Al, Si, Sn, Bi and/or Mo, can be present to improve the layer formation kinetics, wettability and corrosion-protective properties. For a resource-saving method and for reasons of economy, it is preferred if the acidic aqueous composition (II) of the conversion stage in a method according to the invention contains
(a) a total of less than 100 mg/kg, preferably less than 50 mg/kg, particularly preferably less than 10 mg/kg, in particular preferably less than 1 mg/kg of compounds containing chromium, calculated as the amount of chromium,
(b) a total of less than 100 mg/kg, preferably less than 10 mg/kg, of phosphates dissolved in water, preferably of phosphorus-containing compounds dissolved in water, in each case calculated as the amount of phosphorus,
(c) a total of less than 100 mg/kg, preferably a total of less than 10 mg/kg, of hydrolyzable organic silanes and siloxanes calculated as Si(OCH₂CH₃)₄, preferably of compounds of the element silicon dissolved in water calculated as the amount of Si, and/or
(d) a total of less than 0.01 g/L (calculated as solid additive) of copolymers that have, in alternating configuration, monomer units having at least one carboxylic acid group, phosphonic acid group and/or sulfonic acid group and monomer units having no acid group, preferably a total of less than 0.1 g/L (calculated as solid additive) of copolymers that have monomer units having at least one carboxylic acid group, phosphonic acid group and/or sulfonic acid group, particularly preferably less than 0.1 g/L of organic polymers that are not polyamidoamines.

The application and thus the bringing into contact of the acidic aqueous composition (II) preferably takes place at at least 30° C., particularly preferably at least 40° C., but preferably below 60° C. The acidic aqueous composition (II) of the conversion stage can be brought into contact with the components of the series by means of application types established in the prior art. These include in particular dipping, rinsing, spraying and/or misting, wherein application by dipping and/or spraying methods and in particular the immersion of the components of the series in a system basin containing the corresponding acidic aqueous composition (II) is preferred.

### Painting Stage:

In the painting stage, at least the component surfaces that are formed by the hot-dip galvanized (ZM) steel and conversion-coated in method step ii), preferably all the surfaces formed by metallic materials, are coated with a first paint system by bringing the component or at least said surfaces of the conversion-coated hot-dip galvanized (ZM) steel into contact with the aqueous dispersion (III) containing the organic binder. The paint system is therefore deposited directly from the aqueous phase as a coating of the organic binder of the aqueous dispersion (III) precipitated on the aforementioned surfaces, which is usually subjected to thermal post-treatment for film formation and curing. The coating in the painting stage is preferably carried out as dip coating, in particular preferably as electrocoating, and in turn preferably as cathodic electrocoating. For this purpose, the organic binder of the aqueous dispersion (III) is preferably based on amine-modified film-forming polyepoxides, which preferably additionally comprise organic compounds containing blocked and/or unblocked isocyanate groups as hardeners. Inorganic pigments are also often a constituent of the aqueous dispersion and a preferred additive for improving corrosion protection. The aqueous phase also preferably contains small amounts of compounds of the elements yttrium and/or bismuth dissolved or dispersed in water, which have a positive effect on crosslinking and film formation.

The preferred pH of the aqueous dispersion (III) of the painting stage is within the range of 5.0 to 6.0, particularly preferably within the range of 5.4 to 5.8. According to the invention, in the context of the painting stage, the pH corresponds to the negative decadic logarithm of the hydronium ion activity measured in an aqueous dispersion (III) that has been diluted with deionized water (κ<1 μScm⁻¹) by a factor of 10 at a temperature of 20° C. using a pH-sensitive glass electrode after two-point calibration against technical buffer solutions of acetic acid/acetate (pH=4.0) and boric acid/borate (pH=9.0).

The application and thus the bringing of the components or at least said surfaces of the conversion-coated hot-dip galvanized (ZM) steel into contact with the aqueous dispersion (III) preferably takes place at at least 30° C., particularly preferably at least 40° C., but preferably below 60° C. The aqueous dispersion (III) of the painting stage can be brought into contact with the components of the series by means of application types established in the prior art. These include in particular dipping, splashing and roller application, wherein the application by dipping and in particular the immersion of the components of the series into a system basin containing the corresponding aqueous dispersion (III) is preferred and in the case of dipping paints is already predetermined by the type of paint system.

### Procedure:

Preferred embodiments of the method according to the invention are shown and explained below with respect to the individual treatment stages and the method execution, which are particularly advantageous with respect to the object on which the invention is based.

The treatment stages i)-iii) of the process according to the invention each comprise at least one treatment step which provides for bringing the components of the series into contact with an aqueous composition which is characteristic of the treatment stage and is more closely defined. For the purpose of the bringing into contact, these characteristic compositions are either stored or kept in system tanks, and it is possible for the bringing into contact to take place in the system tank, for example by immersion in a composition kept therein, or outside the system tank, for example by misting a composition stored in the system tank in a misting chamber, depending on the specific requirement or preference of the relevant method step.

In the method according to the invention, method steps i)-iii) follow one another, i.e., in the specified order, and preferably in such a way that the components are not subjected to any wet chemical treatment step other than one which is a rinsing step, between two method steps i)-iii). In this context, a rinsing step primarily, preferably exclusively, serves to remove the wet film adhering to the components from the preceding wet chemical method step and thus to completely or partially remove soluble residues, particles and active components that would otherwise be carried over, adhering to the component, from the preceding wet chemical method step to the next treatment stage.

In a preferred method according to the invention, both the degreasing stage and the conversion stage are followed by a so-called rinsing stage comprising at least one rinsing step. Within the rinsing stage, the components of the series are freed from the wet film adhering from the degreasing stage and the conversion stage in order to prevent the carryover of active components into the next treatment stage. To this end, the rinsing stage consists of one or more rinsing steps immediately following one another. Here too, rinsing steps are immediately consecutive if the components are not subjected to another wet-chemical treatment step that is not a rinsing step in the meantime. For the actual function of a rinsing stage, which consists of preventing the carryover of active components into subsequent wet-chemical treatment stages, it is advantageous and therefore also preferred in the context of the present invention if the rinsing stage, as already described, comprises multiple immediately successive rinsing steps for bringing the components of the series into contact with in each case a rinsing solution stored in the system tank of the relevant rinsing step.

For a rinsing stage that follows the degreasing stage and precedes the conversion stage, it is preferred if the specific conductivity in the system tank of the single or last rinsing step is below 100 μScm⁻¹.

For a rinsing stage that follows the conversion stage and precedes the painting stage, it is preferred if the specific conductivity in the system tank of the single or last rinsing step is below 40 μScm⁻¹.

To achieve this purpose, each rinsing stage is supplied with fresh water of a specific conductivity of preferably less than 10 μScm⁻¹, wherein the volume flow of supplied fresh water is large enough to avoid exceeding the maximum specific conductivity specified in each case for the rinsing stage during the treatment of the series of components.

Within the rinsing stage, the wet film from the preceding wet-chemical treatment stage should be removed as thoroughly as possible. The rinsing stage is therefore carried out with rinsing solutions that themselves do not contain any active components of any kind or amount, the carryover of which into the subsequent treatment stage would be problematic and must be prevented. If necessary, however, the rinsing solution can contain small amounts of redox-active compounds (“depolarizers”), such as hydrogen peroxide, or additionally surface-active compounds such as non-ionic surfactants to improve the wettability with the rinsing solution. This applies in particular to the rinsing stage preceding the conversion stage and the painting stage. However, the addition of additives should not mean that the stipulated specific conductivity in the single or final rinsing step of the rinsing stage is exceeded. In particular, a situation should be avoided in which elements and compounds that can have a detrimental effect on the corrosion protection performance are present. Similarly, the addition of additives should always be omitted if it does not thwart the primary purpose of the rinsing stage but does not provide a significant improvement in performance in an essential aspect of the method according to the invention either and would therefore not be economically justified. Therefore, it is preferred if the rinsing solutions of the single or last rinsing step of a rinsing stage in a method according to the invention, preferably any rinsing solution of all rinsing steps of a rinsing stage, contains
(a) in each case less than 10 mg/kg of compounds of the metals Bi, Ni, Co and/or Cu dissolved in water, calculated as the amount of the respective element in the aqueous composition, preferably in each case less than 10 mg/kg of compounds of such metals dissolved in water which have a standard reduction potential of greater than −0.40 V (SHE), calculated as the amount of the respective element in the aqueous composition,
(b) a total of less than 100 mg/kg, preferably less than 50 mg/kg, particularly preferably less than 10 mg/kg, of surfactants, preferably of surface-active organic compounds, particularly preferably of organic compounds,
(c) a total of less than 100 mg/kg, preferably a total of less than 10 mg/kg of organic silanes and siloxanes calculated as Si(OCH₂CH₃)₄, preferably of compounds of the element silicon dissolved in water calculated as the amount of Si,
(d) a total of less than 20 μmol/kg, preferably less than 10 μmol/kg, in particular preferably less than 5 μmol/kg, of compounds of the elements Zr and/or Ti dissolved in water,
(e) a total of less than 50 mg/kg, preferably less than 10 mg/kg each, of sodium and/or potassium ions,
(f) a total of less than 50 mg/kg, preferably less than 10 mg/kg, of zinc ions, (g) a total of less than 100 mg/kg, preferably less than 10 mg/kg, of phosphates dissolved in water, preferably of phosphorus-containing compounds dissolved in water, in each case calculated as the amount of phosphorus, and/or
(h) a total of less than 0.01 g/L (calculated as solid additive) of copolymers that have, in alternating configuration, monomer units having at least one carboxylic acid group, phosphonic acid group and/or sulfonic acid group and monomer units having no acid group, preferably a total of less than 0.1 g/L (calculated as solid additive) of copolymers that have monomer units having at least one carboxylic acid group, phosphonic acid group and/or sulfonic acid group, particularly preferably less than 0.1 g/L of organic polymers,
   wherein the pH of the rinsing solutions is preferably in the range of 5.0 to 8.5.

The standard reduction potential is the reduction potential of the electrochemical half-cell Me/Meⁿ⁺, determined against the normal hydrogen electrode H₂/H⁺ (pH=0), at a metal ion activity of 1 mol/l and at 20° C.

### EXEMPLARY EMBODIMENTS

A plurality of hot-dip galvanized steel sheet portions (each 10 cm×20 cm) of types ZM (CR180 ZM 40/40-EWO from Voestalpine AG) and HDG (Gardobond® MBZ from Chemetall) were corrosion-protectively treated, with the following process steps being carried out. 1.0-2.0 g/m² of an anti-corrosion oil (Anticorit® RP 4107 LV from Fuchs Europe Schmierstoffe GmbH) was applied to the sheets.
A. Cleaning by dipping at a bath temperature of 55° C. for 180 seconds:
   2 g/l BONDERITE® C-AK 2011, 1 g/l BONDERITE® C-AD 1270 (both from Henkel AG & Co. KGaA) in deionized water (κ<1 μScm⁻¹)
   pH: 11.5 (determined with a glass electrode at 25° C.)
   FA: 5 points (10 m¹ sample, pH 8.5)
   GA: 12 points
   PO₄: 2.5 g/l
   Bath volume: 5 liters
B. Rinsing by spraying with deionized water (κ<1 μScm⁻¹) at 20° C. for 30 seconds
C. Rinsing by dipping with deionized water (κ<1 μScm⁻¹) at 20° C. for 30 seconds
D. Conversion treatment by dipping at a bath temperature of 35° C. for 120 seconds
   Zr: 150 mg/kg
   Cu: 10 mg/kg
   Zn: 0.6 g/kg
   NO₃: 6 g/kg
   pH-1: 4.7 (determined with glass electrode at 25° C.)
   pH-2: 4.2 (determined with glass electrode at 25° C.)
   F-free: 40-80 ppm (determined with ion-sensitive electrode at 35° C.)
   The achieved layer weight of Zr was approximately 76-79 mg/m² on HDG, while Zr deposits of 61-64 mg/m² were realized on ZM (each measured via X-ray fluorescence analysis).
E. Rinsing by dipping with deionized water (κ<1 μScm⁻¹) at 20° C. for 30 seconds
F. Rinsing by dipping with deionized water (κ<1 μScm⁻¹) at 20° C. for 30 seconds
G. Drying by blowing with compressed air and storage in a drying cabinet at 50° C.
H. Cathodic dip coating with Cathoguard® 800 (BASF SE) in a dry layer thickness of 28-30 μm
I. Topcoat build-up with (thin-film filler ALG 697 172; BC: Brilliant Black ALD 091 Y9B; CC: ALD 096 100, each from Audi AG) in a dry layer thickness of 105-115 μm

To simulate a corrosion protection treatment in series, a plurality of sheets were cleaned one after the other (alternating first with ZM, then HDG) and in this way an increasing concentration of hydrocarbons was set. The results in terms of corrosion protection are summarized in tables 1 and 2.

In the present series of tests, the critical threshold value for hydrocarbons, above which a significant deterioration (cross-cut value >2) of the corrosion protection on the (ZM) sheets could be observed, was approximately 0.10 kg/m³, which corresponded to approximately 12 sheets put through. However, it was found that by increasing the minimum amount of free fluoride, good protection against corrosive delamination of the paint system could be maintained. Overall, it was also found that lower pH values in the conversion stage, with the same bath loading with nonpolar hydrocarbons, make a higher free fluoride proportion necessary to maintain good corrosion protection.

TABLE 1
Results of the cross-cut test (DIN EN ISO 2409) after corrosion-
protective treatment (conversion stage with pH-1 = 4.70)

| | Number of | KW^{#} | Free fluoride | HDG cross- | ZM cross- |
|---|---|---|---|---|---|
| | sheets* | (kg/m³) | (mg/kg) | cut value | cut value |
| CE1 | 0 | — | 40 | 0 | 0 |
| CE2 | 6 | 0.047 | 40 | 0 | 1 |
| CE3 | 12 | 0.099 | 40 | 0 | 3 |
| CE4 | 24 | 0.199 | 40 | 0 | 4 |
| CE5 | 48 | 0.410 | 40 | 0 | 5 |
| E1 | 8 | ND | 55 | 0 | 0 |
| E2 | 14 | ND | 50 | 0 | 1 |
| E3 | 16 | ND | 60 | 0 | 0 |
| E4 | 26 | ND | 60 | 0 | 1 |
| E5 | 28 | ND | 70 | 0 | 0 |
| E6 | 50 | ND | 60 | 0 | 2 |
| E7 | 52 | ND | 70 | 0 | 1 |
| E8 | 54 | ND | 80 | 0 | 0 |

*Number of sheets already put through at the time of corrosion-protective treatment
^{#}Amount of nonpolar hydrocarbons in the degreasing stage determined according to the analytical method mentioned in the description, based on the corresponding number of sheets put through
ND not determined

TABLE 2
Results of the cross-cut test (DIN EN ISO 2409) after corrosion-
protective treatment (conversion stage with pH-2 = 4.20)

| | Number of | KW^{#} | Free fluoride | HDG cross- | ZM cross- |
|---|---|---|---|---|---|
| | sheets* | (kg/m³) | (mg/kg) | cut value | cut value |
| CE1 | 0 | — | 40 | 0 | 0 |
| CE2 | 6 | 0.048 | 50 | 0 | 1 |
| CE3 | 12 | 0.098 | 40 | 0 | 3/4 |
| CE4 | 24 | 0.211 | 40 | 0 | 4/5 |
| CE5 | 48 | 0.404 | 40 | 0 | 5 |
| E1 | 8 | ND | 66 | 0 | 0 |
| E2 | 14 | ND | 60 | 0 | 1 |
| E3 | 16 | ND | 70 | 0 | 0 |
| E4 | 26 | ND | 60 | 0 | 1 |
| E5 | 28 | ND | 75 | 0 | 0 |
| E6 | 50 | ND | 60 | 0 | 3 |
| E7 | 52 | ND | 75 | 0 | 1 |
| E8 | 54 | ND | 90 | 0 | 0 |

*Number of sheets already put through at the time of corrosion-protective treatment
^{#}Amount of nonpolar hydrocarbons in the degreasing stage determined according to the analytical method mentioned in the description, based on the corresponding number of sheets put through
ND not determined

1. A method for corrosion-protective pretreatment of a plurality of components in series, in which the components of the series at least partially have surfaces of zinc-magnesium hot-dip coated steel, and in which the components of the series each undergo successive method steps i)-iii), and at least the surfaces of the zinc-magnesium hot-dip coated steel are successively brought into contact with respectively provided aqueous solutions (I)-(III):
i) degreasing stage providing an alkaline aqueous composition (I) having a pH above 9.00;
ii) conversion stage providing an acidic aqueous composition (II) having a pH in the range of 3.50 to 5.20, containing at least 0.05 mmol/kg of compounds of the elements Zr and/or Ti dissolved in water and at least 2.80 mmol/kg of free fluoride; and
iii) painting stage providing an aqueous dispersion (III) of an organic binder.

2. The method according to claim 1, wherein the alkaline aqueous composition (I) of the degreasing stage in method step i) contains more than 0.05 kg/m³ of nonpolar hydrocarbons.

3. The method according to claim 1, wherein the acidic aqueous composition (II) of the conversion stage in method step ii) contains at least 3.00 mmol/kg but less than 7.50 mmol/kg of free fluoride.

4. The method according to claim 1, wherein the acidic aqueous composition (II) of the conversion stage in method step ii) contains a minimum amount of free fluoride in mmol/kg, which is calculated according to the following term:
$$4.4 - \frac{2.4}{1.7} \cdot ( pH - 3.5 ) ,$$
wherein, in each case, the pH of the acidic aqueous composition (II) is to be used for the pH.

5. The method according to claim 2, wherein the acidic aqueous composition (II) of the conversion stage in method step ii) contains a minimum amount of free fluoride in mmol/kg, which is calculated according to the following term:
$$1.2 + 5 \cdot \sqrt{0.1 \cdot KW} + 1.85 \cdot \sqrt{5.2 - pH}$$
where
pH is the pH of the acidic aqueous composition (II), which is less than 4.80; and
KW is a dimensionless proportion of nonpolar hydrocarbons in the alkaline aqueous composition (I) in the system tank of the degreasing stage in kg/m³, which is at least 0.10 kg/m³.

6. The method according to claim 1, wherein the acidic aqueous composition (II) of the conversion stage in method step ii) contains as the source for the compounds of the elements Zr and/or Ti dissolved in water the corresponding fluoro acids and/or their water-soluble salts.

7. The method according to claim 1, wherein the acidic aqueous composition (II) of the conversion stage in method step ii) contains at least 0.10 mmol/kg but less than 5.0 mmol/kg of compounds of the elements Zr and/or Ti dissolved in water, based on the elements Zr and/or Ti.

8. The method according to claim 1, wherein the acidic aqueous composition (II) of the conversion stage in method step ii) has a pH of greater than 4.00 and less than 5.10.

9. The method according to claim 1, wherein the acidic aqueous composition (II) of the conversion stage in method step ii) additionally contains copper ions dissolved in water.

10. The method according to claim 1, wherein the bringing into contact with the conversion solution (II) in the conversion stage is carried out at least for a duration sufficient to result in deposition of a layer deposit of at least 20 mg/m² on the surfaces of the zinc-magnesium hot-dip coated steel, but the bringing into contact does not continue for so long that a layer deposit of more than 250 mg/m² results, in each case based on the elements Zr and/or Ti on these surfaces.

11. The method according to claim 1, wherein the bringing into contact of the painting stage in method step iii) is dip coating including cathodic electrocoating comprising an amine-modified polyepoxide as an aqueous dispersion of an organic binder (III).

12. The method according to claim 11, wherein the aqueous dispersion additionally contains water-soluble or water-dispersible salts of yttrium and/or bismuth.

13. The method according to claim 1, wherein the alkaline aqueous composition (I) of the degreasing stage in method step i) contains more than 0.20 kg/m³ of nonpolar hydrocarbons; and an intermediate rinse is performed during the transfer of the components from method step stage i) or stage ii) to the next, and method steps i)-iii) otherwise immediately follow one another.

14. The method according to claim 1, wherein the components of the series are composite structures composed of semi-finished products of zinc-magnesium hot-dip coated steel and of semi-finished products of galvanized steel and aluminum.

15. The method according to claim 1, wherein the components are automotive bodies assembled from semi-finished products of zinc-magnesium hot-dip coated steel and from semi-finished products of galvanized steel, aluminum and steel.

16. The method according to claim 4, wherein the acidic aqueous composition (II) of the conversion stage in method step ii) contains a minimum amount of free fluoride in mmol/kg, which is calculated according to the following term:
$$4.4 - \frac{1.6}{1.7} \cdot ( pH - 3.5 ) ,$$
wherein, in each case, the pH of the acidic aqueous composition (II) is used for the pH; the acidic aqueous composition (II) of the conversion stage in method step ii) contains at least 0.40 mmol/kg, but less than 5.0 mmol/kg of compounds of the elements Zr and/or Ti dissolved in water, based on the elements Zr and/or Ti; and additionally contains copper ions dissolved in water in an amount of at least 0.05 mmol/kg, but less than 4.0 mmol/kg.
